(19) United States
(12) Patent Application Publication
(10) Pub. No.: US 2020/0329849 A1
(43) Pub. Date: Oct. 22, 2020

(54) PROTECTIVE FACIAL PATCHES AND METHOD OF USE

(71) Applicants: Anneli Freer, Los Angeles, CA (US); Kamil Bugra Toga, Ann Arbor, MI (US); Hyeonsoo Kim, Ann Arbor, MI (US); Aileen Reene Peer, Ann Arbor, MI (US)

(72) Inventors: Anneli Freer, Los Angeles, CA (US); Kamil Bugra Toga, Ann Arbor, MI (US); Hyeonsoo Kim, Ann Arbor, MI (US); Aileen Reene Peer, Ann Arbor, MI (US)

(73) Assignee: ITRIPATCH LLC, West Hollywood, CA (US)

(21) Appl. No.: 16/850,721

(22) Filed: Apr. 16, 2020

Related U.S. Application Data
(60) Provisional application No. 62/834,922, filed on Apr. 16, 2019.

(51) Int. Cl. A45D 44/12; B32B 27/40; B32B 7/12; B32B 7/06; C09J 183/04

(52) U.S. Cl. CPC A45D 44/12; B32B 27/40; B32B 7/12; B32B 7/06; B32B 2556/00; A45D 2200/10; B32B 2307/402; B32B 2307/412; B32B 2307/538; C09J 183/04

(57) ABSTRACT

A system for protecting a person's facial skin from contaminants due to the application of makeup is disclosed. The system may include one or more patches that may be applied to the person's eyelids, cheeks, lips or other locations, upon which makeup may then be applied. In this way the makeup is applied to the top surface of the patches and not directly to the person's skin. The system may thereby prevent microbes (e.g., bacteria, viruses, etc.) from being transferred from the makeup and/or the makeup applicator to the person's skin.

### RELATIONSHIPS TO PRIOR ARPPLICATIONS

This application claims priority to U.S. Provisional Application No. 62/834,922, filed Apr. 16, 2019, the entire contents of which are hereby fully incorporated herein by reference for all purposes.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to protective devices and systems, including protective facial patches used during the application of cosmetics.

### BACKGROUND

It is not uncommon for a potential customer of makeup to try on different colors and/or shades of makeup at a store's makeup counter prior to purchasing the makeup. In this way, the customer may see firsthand how they may appear while wearing the desired color and/or shade prior to purchase.

However, it is also not uncommon for the sample makeup to be applied using a makeup applicator that has been used prior by other potential makeup customers. Accordingly, the sample makeup and makeup applicator may include undesirable microbes (e.g., bacteria, viruses, fungi, etc.) from the prior use that may be transmitted to the current user. For example, the makeup and/or the makeup applicators may include Staphylococcus aureus, Haemophilus influenzae, Streptococcus pneumoniae and/or Pseudomonas aeruginosa that may cause conjunctivitis (also known as pink eye) and other infectious diseases or infections.

Accordingly, there is a need for a system that may protect a person from unwanted contaminants while trying on makeup. There is also a need for one or more protective layers that may protect a person's skin from unwanted contaminants while trying on makeup.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows aspects of a protective system according to exemplary embodiments hereof;

FIGS. 2A-2D show aspects of a patch according to exemplary embodiments hereof;

FIGS. 3A-3J show aspects of a protective eyelid patch according to exemplary embodiments hereof;

FIGS. 4A-4D show aspects of a protective cheek patch according to exemplary embodiments hereof;

FIG. 5 shows aspects of a protective lip patch according to exemplary embodiments hereof;

FIG. 6 shows aspects of a protective eyelid patch according to exemplary embodiments hereof; and

FIG. 7 shows a table of protective patch characteristics according to exemplary embodiments hereof.

### DETAILED DESCRIPTION OF EXEMPLARY EMBODIMENTS

A system according to exemplary embodiments of the current invention is described with reference to the figures.

In general, the protective system according to exemplary embodiments hereof may provide protection from undesirable contaminants such as microorganisms (e.g., bacteria, viruses, fungi, etc.) and other types of contaminants.

In one exemplary embodiment hereof, the protective system may include one or more patches or layers that may be applied to a person's skin in order to protect it thereby. For example, in one preferred implementation, the patch is applied to a portion of a person's face (e.g., the person's eyelids, cheeks, lips, etc.) while the person is trying on makeup or cosmetics (e.g., at a store, makeup counter, spas, hair salons, exhibits, etc.). The makeup or cosmetics is then be applied to the outer surface of the protective layer and not directly to the person's skin. In this way, the protective layer thereby prevents the transfer of any undesirable microorganisms such as bacteria, viruses, fungi, dirt, other types of microorganisms, chemicals and/or other types of contaminants from the makeup and/or makeup applicator to the skin underneath the layer. In this way it can be seen that the patch may help to prevent infections on the person's face due to transferred bacteria or viruses.

The system 10 may include a patch, thin film, strip, shield, sheet, substrate or any other type of layer that may be temporarily applied to a person's body (e.g., a person's face) while applying makeup or cosmetics. The patch may also be referred to as a protective patch or layer. In some embodiments, the system 10 includes a soft, translucent, disposable patch that may be used and subsequently discarded.

For the purpose of this specification and for demonstration, the system and its method of use will be described primarily in relation to the application of makeup and cosmetics. However, it will be understood by a person of ordinary skill in the art, upon reading this specification, that the system may be used in any application that may benefit from the system, and that the scope of the system is not limited in any way by the type of application of the system.

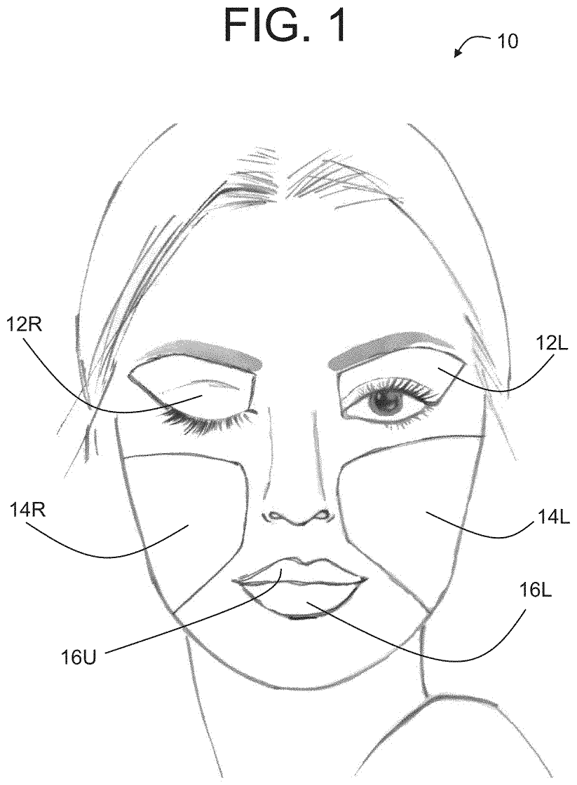

In one exemplary embodiment hereof as shown in FIG. 1, the system 10 may include one or more patches that may be applied to a person's face and/or body. Makeup and cosmetics may then be applied directly to the protective layer(s). For example, the system 10 may include an eyelid patch 12, a cheek patch 14, a lip patch 16, a chin patch, a forehead patch and other patches that may be configured with other areas of the person's face and/or body (e.g., with the user's arms, hands, palms, fingertips, etc.). The eyelid patch 12 may include a left eyelid patch 12L and/or a right eyelid patch 12R (individually or collectively 12), the cheek patch 14 may include a left cheek patch 14L and/or a right cheek patch 14R (individually and collectively 14), and the lip patch 16 may include an upper lip patch 16U and a lower lip patch 16L (individually and collectively 16). In addition, the patches 12, 14, 16 may be combined in any way. For example, the upper lip patch 16U and the lower lip patch 16L may be combined to form an overall lip patch 16.

For the purposes of this specification and for demonstration, the details of the patches (e.g., patches 12, 14,16 and/or any other patch adapted to cover any other portion of the user's body) and each patch's one or more layers will be described primarily in relation to the eyelid patch 12. However, it is understood that the details described herein may pertain to any patch 12, 14, 16, and/or any other patch adapted to cover any other body areas. It is also understood that the scope of the system 10 is not limited in any way by the body area(s) that the patches may be designed to cover.

In one exemplary embodiment hereof, each protective patch 12 may include one or more layers. The patch 12 may preferably be fabricated as a film and die-cut into different shapes that adequately cover the target area on the face (e.g., eye lids, lips, cheeks, chin, forehead, etc.) or body (etc., arms, hands, palms, fingertips, etc.). The patch 12 may be made of a single layer of clear and/or pigmented elastomeric resin, and/or may include multiple layers of similar or dissimilar resins and/or other functional layers (e.g., primers, adhesives, transfer layers for make-up, etc.).

In one exemplary embodiment hereof, one or more layers of the patch 12 may comprise a polymer material, polyurethane, an elastomer, latex, latex composite, polyolefin, polyethylene, polypropylene, polyisoprene, polystyrene, polybutadiene, polyacrylate, polymethacrylate, polyacrylamide, polyester, polyamide, polyuria, polyether, silicone, polyose, cellulose, wax, and/or other materials, and any combination thereof. The patch 12 may include materials that may include natural fibers, a fabric or other woven form, a paper or other non-woven form, wood, bio-cellulose and other types of fibers and materials. It is understood that the patch 12 and the layers that may make up the patch 12 may include any materials or combinations of materials that meet the requirements of the system 10.

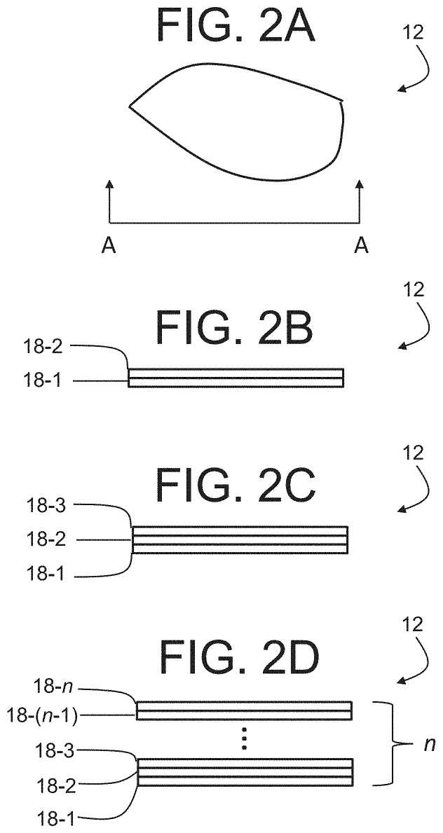

As shown in FIG. 2A, the system may include an eyelid patch 12. FIGS. 2B and 2C show the eyelid patch from the perspective of the cut lines A-A of FIG. 2A. In some embodiments, the patch 12 may include one or more layers 18-1, 18-2, 18-3, . . . 18-n (individually and collectively 18). For example, the patch 12 may include two layers 18-1, 18-2 as shown in FIG. 2A, three layers 18-1, 18-2, 18-3 as shown in FIG. 2C, and n-layers 18-1, 18-2, 18-3, . . . 18-n as shown in FIG. 2D.

In one exemplary embodiment hereof, a first layer 18-1 (e.g., the bottom layer) of the patch 12 may include protective layer 18-1 (e.g., a carrier layer or plastic strip) that may cover and protect a second layer 18-2 that may include an adhesive layer 18-2. This may be beneficial when the patch 12 may be in storage and not in use. The protective layer 18-1 may then be removed (e.g., by peeling it off) in order to expose the adhesive layer 18-2 underneath. The adhesive layer 18-2 may secure the patch 12 to the person's face. Once the adhesive may be exposed, the patch 12 may be applied. The patch 12 also may include a third (or top) layer 18-3 that protects the user's skin from contaminants and upon which the cosmetics may be applied.

In one preferable embodiment, the patch 12 is easily peeled off from the carrier layer 18-1 by fingers or the aid of tweezers or similar grabbing utensils. Accordingly, the release liner 18-1 preferably comprises flexible material(s) like paper, polyolefin films, or polyester films, and coated at the release surface with an appropriate resin (e.g. polyethylene, silicones, fluorinated silicones etc.) that reduces the surface energy of the release surface.

It may be preferable that the adhesive be strong enough to secure the patch 12 to the person's skin so that the patch 12 may not move during the application of the makeup or cosmetics. It may also be preferable that the adhesive be weak enough that the patch 12 may be easily removed (e.g., by peeling it off the skin) without undue effort and/or without causing undue irritation to the person's skin. In this way the patch 12 may be temporary. It may also be preferable that the adhesive not cause irritation, rashes, or any other types of undesirable skin conditions when used. In one preferred implementation, the adhesive may include a pressure sensitive acrylic adhesive. However, it is understood that any type of adhesive that may include the necessary criteria and performance may be used.

In one exemplary embodiment hereof, the patch 12 may be a single use patch and may be discarded after it is removed (e.g., the patch 12 may be disposable). In another exemplary embodiment hereof, the patch 12 may be a multi-use patch and may be cleaned (e.g., wiped off) and reused. In this embodiment, it may be preferable that the adhesive include multi-use adhesive.

In one exemplary embodiment hereof, a top layer 18-3 of the patch 12 may include a surface that may be configured to receive the makeup or cosmetics. For example, the top surface of the patch may include a slight texture so that the makeup or cosmetics may adhere properly to the patch 12 when applied without smearing. In one preferable implementation, the top surface of the patch may include a texture that may receive and hold the makeup or cosmetics in a fashion that may resemble human skin. To this end, the top surface of the patch 12 may include a mat finish, a glossy finish, a textured finish and any combination thereof.

In one example of this as shown in FIG. 2C, the top layer 18-3 may include a textured layer to receive the makeup and cosmetics, the middle layer may include a layer that may provide protection from the aforementioned contaminants, and the bottom layer may include an adhesive layer.

In one embodiment as shown in FIG. 2D, the top layer 108-n may include a textured top surface (e.g., roughed or otherwise textured) to receive the makeup and cosmetics such that the makeup and/or cosmetics may generally adhere to the top surface of the layer 108-n, any number of inner layers 18-3 to 18-(n-1), individually or in combination, may provide protection from contaminants, a lower layer 18-2 may include an adhesive layer, and the bottom layer 18-1 may include a removable carrier layer that protects the adhesive layer 18-2. In this example, one or more inner layers may provide protection from bacteria, the same or other one or more inner layers may provide protection from viruses, the same or other one or more inner layers may provide protection from fungi, the same or other one or more inner layers may provide protection from any other undesirable microorganisms and/or contaminants, and any combination thereof as required by the system 10.

It is understood by a person of ordinary skill in the art that the above examples are meant for demonstration and that they patch 12 may include any number of layers, and that any individual layer and/or any combination of layers may be used as protective layers as described. It is also understood that the scope of the system 10 is not limited in any way by the number and/or use of each individual layer, any combination of layers, and any combination thereof.

In some embodiments, the protective layers may provide protection from the contaminants by physically preventing the contaminants from passing from the top surface of the patch 12 to the bottom surface of the patch 12. For example, the layers may include molecular structures that may be impenetrable to bacteria, viruses, fungi and/or other types of microorganisms. In this way, it may be preferable that no bacteria, virus, fungi, other microorganisms or other types of undesirable contaminants be able to physically pass from the top surface of the patch 12 to the bottom surface of the patch 12, and onto the person's skin underneath. The patch 12 and its layers may include any type of materials that may be adequate for these purposes.

In another exemplary embodiment hereof, one or more of the layers of the patch 12 may include antimicrobial, antibacterial, antiviral and/or antifungal elements that may kill or otherwise inhibit and/or eliminate any microbes (e.g., bacteria and/or viruses) that may come into contact with the layers of the patch 12. In this way, the patch 12 may kill or otherwise prevent the bacteria and/or viruses from passing through the patch 12 to the skin underneath. For example, one or more layers of the patch 12 may be impregnated with agents such as polyhexamethylene biguanide (PHMB), ionic silver or other types of antimicrobial agents or elements. In another example, one or more layers of the patch 12 may include nanoparticles and/or nanomaterials (e.g., nano-silver) that may act as antimicrobial agents.

As shown in FIG. 1, the patches 12, 14, 16 may include a variety of shapes and sizes. In one exemplary embodiment hereof, the shapes and sizes of each patch 12, 14, 16 may be designed to provide protection to the area of the face to which makeup and cosmetics may be wished to be applied. For example, in one embodiment, the eyelid patches 12 may include shapes, sizes and contours so that each patch 12 may cover the area of the eyelid between the eyelash and the eyebrow. In this way eyeshadow (or other makeup) may be applied to this area and the skin underneath the patches 12 may be protected.

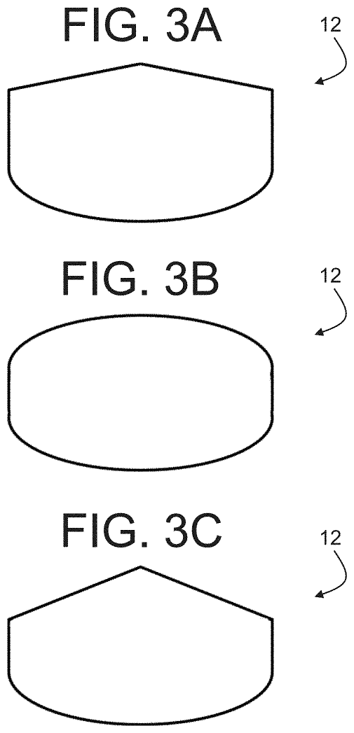

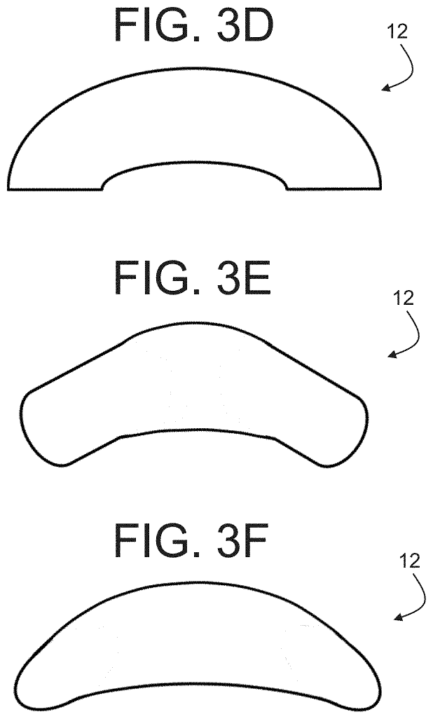

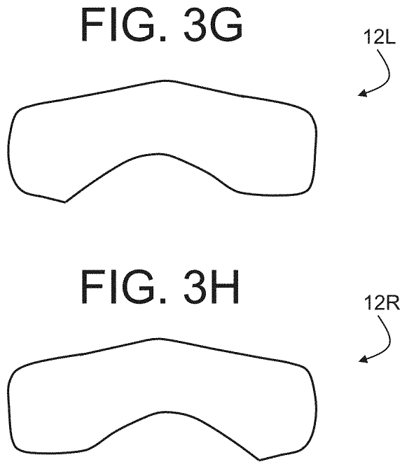

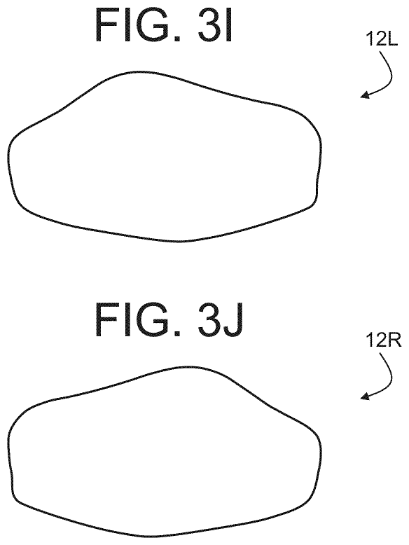

In some embodiments, the shapes of the patches 12, 14, 16 are symmetrical while in other embodiments the shapes of the patches 12, 14, 16 are asymmetrical. For example, FIGS. 3A-3F show symmetrical eye patch shapes and FIGS. 3G-3J show asymmetrical eye patch shapes. Accordingly, the shapes shown in FIGS. 3A-3F may be placed on either the left eyelid or the right eyelid, while the shapes shown in FIGS. 3G and 31 are specifically meant for application onto the left eyelid while the shapes shown in FIGS. 3H and 3J are specifically meant for application onto the right eyelid.

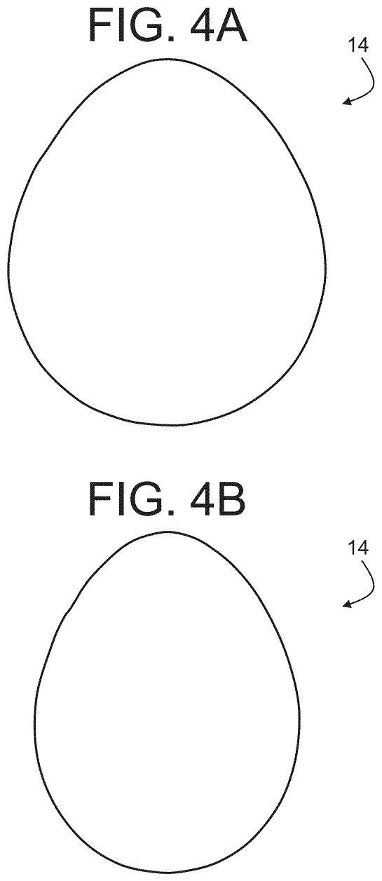

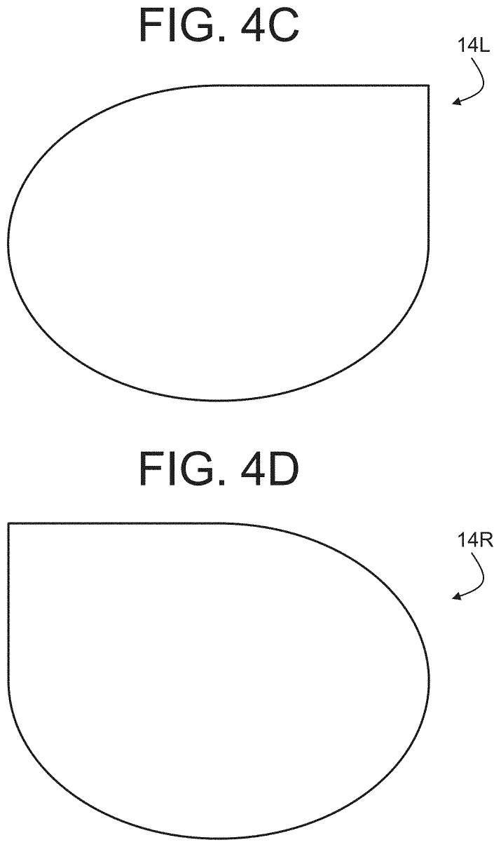

Similarly, FIGS. 4A-4B show symmetrical cheek patch shapes and FIGS. 4C-4D show asymmetrical cheek patch shapes. Accordingly, the shapes shown in FIGS. 4A-4B may be placed on either the left cheek or the right cheek, while the shape shown in FIGS. 4C is specifically meant for application onto the left cheek while the shape shown in FIGS. 4D is specifically meant for application onto the right cheek.

FIG. 3A shows a patch shape with a generally upward pointing triangular upper portion, a generally downward facing arced (e.g., generally parabolic) lower portion, and generally vertical left and right side portions.

FIG. 3B shows a patch shape with a generally upward facing arced (e.g., generally parabolic) upper portion, a generally downward facing arced (e.g., generally parabolic) lower portion, and generally vertical left and right side portions.

FIG. 3C shows a patch shape with a generally upward pointing triangular upper portion, a generally downward facing arced (e.g., generally parabolic) lower portion, and generally vertical left and right side portions. Note that the patch shape of FIG. 3C is similar to the patch shape of FIG. 3A with a more upright upper triangular portion.

FIG. 3D shows a patch shape with a generally upward facing arced (e.g., generally parabolic) upper portion, a generally upward facing arced (e.g., generally parabolic) lower middle portion, and generally horizontal left and right bottom portions.

FIG. 3E shows a patch shape with a generally upward facing arced (e.g., parabolic) top portion, outward and downward facing left and right side tabs and a generally upward facing arced (e.g., parabolic) bottom middle portion.

FIG. 3F shows a patch shape with a generally upward facing arced (e.g., generally parabolic) upper portion, a generally upward facing arced (e.g., generally parabolic) lower middle portion, and generally rounded left and right bottom side portions.

FIG. 3G shows a patch shape with a generally upward pointing triangular upper portion, a generally upward facing arced (e.g., generally parabolic) lower portion, and generally vertical left and right side portions.

FIG. 3H shows a patch shape generally mirroring the patch shape of FIG. 3G.

FIG. 3I shows a patch of generally rectangular shape with rounded corners and an upward facing hump in the middle top portion and a downward facing hump in the middle bottom portion.

FIG. 3J shows a patch shape generally mirroring the patch shape of the FIG. 31.

In some embodiments, the shapes shown in FIGS. 3A-3J may be about 2.0″ to 2.5″ in width and about 1.0″ to 1.5″ in height. Note that other dimensions may also be used.

In another embodiment, the cheek patches 14 may include shapes, sizes and contours so that each cheek patch 14 may cover the desired portions of the person's cheeks such that blush (or other makeup) may be applied to these areas and the skin underneath the patches 14 may be protected.

FIGS. 4A and 4B show patch shapes with a generally oval shape. In some embodiments, the lower portions may be slightly wider than the upper portions so that the shapes are egg-shaped.

In some embodiments, the shape shown in FIG. 4A may be about 3.0″ in width and about 3.5″ in height. Note that other dimensions may also be used.

In some embodiments, the shape shown in FIG. 4B may be about 2.5″ in width and about 3.25″ in height. Note that other dimensions may also be used.

FIG. 4C shows a patch shape with a generally oval shape except for the upper right portion that may include a corner formed by a right vertical portion converging with a right horizontal portion. This shape may also be referred to as teardrop shaped with the apex of the teardrop generally pointing at an upper 45° angle.

FIG. 4D shows a patch shape generally mirroring the patch shape of FIG. 4C.

In some embodiments, the shapes shown in FIGS. 4C and 4D may be about 4.0″ in width and about 3.0″ in height. Note that other dimensions may also be used.

In another embodiment, the lips patch 16 may include shapes, sizes and contours so that each lip patch 16 may cover the desired portions of the person's lips such that lipstick, lip balm or other types of lip products may be applied to these areas and the skin underneath the patches 16 may be protected.

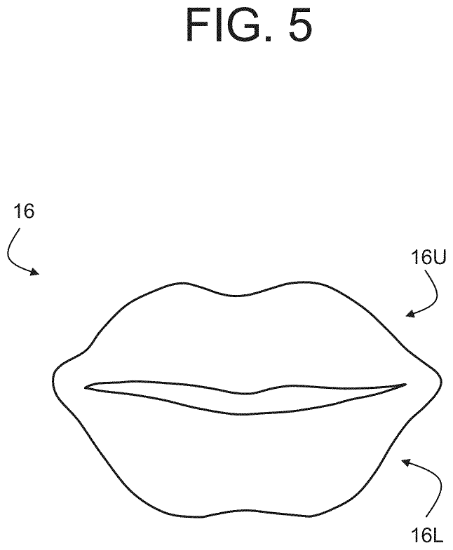

FIG. 5 shows a patch shape generally in the shape of upper and lower human lip outlines. Note that this shape may also be formed as two shapes, with a first shape the shape of the upper human lip and the second shape the shape of the lower human lip.

In some embodiments, the shape shown in FIG. 5 may be about 3.0″ to 3.5″ in width and about 2.0″ in height. Note that other dimensions may also be used.

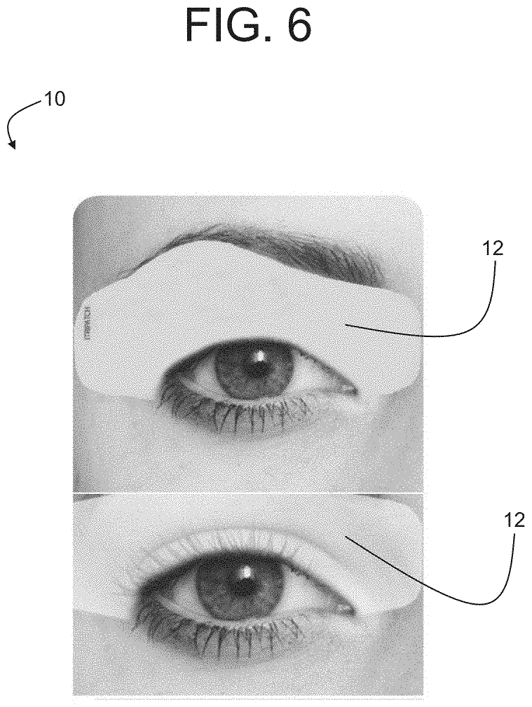

It is understood that the contours, shapes and sizes of the system 10 and the patches 12, 14, 16 described in the above examples and as shown in FIGS. 1 and 2 are meant for demonstration purposes and that the system 10 and the patches 12, 14, 16 may include any contours, shapes and sizes, and combinations of contours, shapes and sizes to cover any portion or combinations of portions of the person's face or other skin as required. It is also understood that the patches 12R, 12L may or may not match, and that the patches 14R, 14L may or may not match. FIG. 6 shows an eyelid patch 12 applied to a person's eyelid.

The patches 12 may be laser cut, die cut, kiss cut and/or cut using other cutting methods into different shapes after the coating process and may be packaged as a roll or as individual patches 12. The patch 12 may optionally be cast/molded directly into cavities that resemble capsules/tablet packaging. The molded or thermoformed structure may be used both for fabrication and as a packaging solution for the consumer.

It may be preferable that the patches 12, 14, 16 be comfortable when worn and that the patches 12, 14, 16 may not adversely inhibit the movement of the person wearing the patches 12, 14, 16. For example, it may be preferable that the eyelid patches 12 not inhibit the wearer from blinking, or the cheek patches 14 and/or the lip patches 16 not inhibit the wearer from smiling.

Exemplary Properties

In one exemplary embodiment hereof, the patch 12 is thick enough to be handled easily by hand or by using a utensil (e.g., tweezers), and thin enough to be smoothly formed onto curved surfaces like eye lids, lips, cheeks and/or other body parts. In one embodiment, the preferred thickness of the patch 12 is 1-3 mils. In other embodiments, the patch 12 may be 0.5-10 mils depending on the mechanical properties of the resin used to form the patch layer 12.

In some embodiments, the thickness of the patch 12 is controlled by melt extrusion and/or appropriately metering the patch layer using a liquid casting method (e.g. extrusion coating, slot die coating, curtain coating etc.). The casting process may be followed by a curing and/or drying process, for example, by using a heat source and/or radiation.

In some embodiments, the patch 12 is preferably soft enough to provide comfort to the user during its application and use. In some embodiments, the patch's preferred Shore A Hardness values range between 45 and 65. In other embodiments, the patch's Shore A Hardness values range from 25 to 95.

In some embodiments, the patch's adhesive layer is tacky enough to stick onto the user's skin during the application of makeup or other substances, and weak enough to be easily peeled off from the skin after the application without leaving any residue on the skin surface or causing discomfort to the user. In some embodiments, the preferred adhesion strength ranges from 0.25 to 1.0 N per 2.5 cm. In other embodiments, the adhesion strength ranges from 0.05 to 2.0 N per 2.5 cm.

In some embodiments hereof, the patch 12 may be transparent, opaque, solid colored and any combination thereof. For example, the layers that make up the patches 12, 14, 16 may all be transparent, may all be opaque, may include pigments, may all be solid colored, may include a gradient of pigment, or may be a combination of transparent, opaque, pigmented, solid colored and/or with a gradient of pigment. Other patterns of transparent and/or pigmented portions may also be included. In some embodiments, the various layers of the patch 12 are preferentially made from translucent and/or transparent resins that demonstrate low haze levels. In this way, the color of the underlying skin at the point of application may be viewed through the patch 12. In some embodiments, the patch 12 comprises non-woven material (e.g., non-woven fabrics), paper, or similar textured materials. These materials may be preferred for ease of application, ideal pigmentation of color cosmetics, and easy disposal. In other embodiments, the patch 12 and adhesive may be selected from renewable feedstock such that the patches 12 are environmentally friendly. In some embodiments, the patch resins may comprise polymers of silicones, esters, ethers, urethanes, acrylates, methacrylates, synthetic rubbers (e.g., isobutylene, isoprene, styrene and ethylene). Note also that miscible resins from the list above may be blended to create a compounded solution for the soft, elastomeric layer of the patch 12.

In some embodiments, the physical properties of each layer (e.g. haze, surface texture, adhesion, etc.) can be tuned using organic additives (e.g., natural oils, synthetic oils, plasticizers, tackifiers, UV stabilizers, antioxidants) and/or inorganic additives (e.g., Fumed Silica, Nano Silica, Zinc oxide, zirconia, titanium oxide etc.).

In some embodiments, the surfaces of the patches 12 may be modified to enhance pigmentation from color cosmetics as well as the wetting properties for appropriate application of the adhesive during manufacturing. The modification may include a physical processing (e.g., embossing a rough texture onto the surface) and/or a chemical processing (e.g., corona treatment). In addition, a top primer layer on the patch 12 may be provided for better pigmentation of the color cosmetics.

In one exemplary embodiment hereof, the system 10 and the patch 12 may come in different colors. For example, the system 10 and the patch 12 may be provided in a variety of skin tones. In this way, the person using the system 10 may choose a system 10 and the patches 12 that may most closely resemble his/her own skin tone. This may enable the makeup, once applied to the patches 12, to more closely represent how the makeup may appear if applied directly to the person's skin.

In another exemplary embodiment hereof, the system 10 and the patches 12 may be provided with makeup pre-applied to the patches 12. The makeup applied to each patch 12 may or may not match. In other exemplary embodiments hereof, the system 10 and the patches 12 may come in colors that may represent the different shades and colors that may be available as makeup. The colors of the patches 12 may or may not match. It is understood by a person of ordinary skill in the art that the system 10 and the patches 12 may come blank, in any colors, with any type of makeup pre-applied and any combination thereof, and that the scope of the system 10 and of the patches 12 is not limited in any way by the color of the patches 12 or by the color and/or the type of any makeup that may be pre-applied to the patches 12.

In one exemplary embodiment hereof, the system 10 and the patches 12 may come as a part of a kit that may include the makeup, the makeup applicators and other products. In this way, the patches 12 may include colors, shapes, sizes and other aspects that may be more particularly pertain to the makeup that the system 10 may be included with.

In Use

One exemplary method by which the system 10 and the patches 12, 14, 16 may be used, may include the steps described below, without limitation:
1. Choosing the type of makeup or cosmetics to be tested (e.g., eye shadow).
2. Choosing the type of patch 12, 14, 16 that may be associated with the type of makeup chosen in (1). Following the example provided in (1) (e.g., for use with eye shadow), this may include choosing the eyelid patch 12.
3. Choosing a shape and size of the type of patch 12 to be used. For example, the eyelid patch may come in small, medium and large sizes, and the appropriate size for the particular person may be chosen.
3. Removing the adhesive protection strip from the bottom of the patch 12 to expose the adhesive layer.
4. Placing the patch 12 onto the eyelid with the adhesive side facing the skin and applying pressure to adhere the patch 12 to the skin.
5. Applying one or more types of makeup to the top surface of the patch 12.
6. (Optional) Wiping the makeup off the patch 12 and applying different makeup, or a different amount of makeup, to the top surface of the patch 12.
7. (Optional) Repeating step (6) as often as desired.
8. Removing the patch 12 from the skin.
9. Discarding the used patch 12, and/or cleaning the used patch 12 for reuse.
10. Repeating any of the above steps as desired.

Note that while the steps described above used the eyelid patch 12 as an example, it is understood that similar methods including similar steps may be used for any other type of patch(es) that may be included with the system 10.

It is understood that while this specification describes patches 12 that may be primarily applied to a person's eyelids, cheeks and/or lips, the system 10 and its patches 12 may be applied and used with any element or portions of a person's body. It is also understood that any and/or all of the aspects of the patches 12 may pertain to any of the patches that may be applied to any portions of the person's body.

### EXAMPLES

Additional embodiments and details of the patch 12 will be described by way of several detailed in-use examples. The examples provided below are chosen to illustrate various embodiments and implementations of the patch 12 and its various elements and characteristics, and those of ordinary skill in the art will appreciate and understand, upon reading this description, that the examples are not limiting and that the patch 12 may include other materials and/or elements and may be used in different ways. It is also understood that details of different embodiments described in different examples may be combined in any way to form additional embodiments that are all within the scope of the patch 12.

I. Patch Layer

In some embodiments, the patch layer may comprise clear elastomeric resins, which may be melt extruded, solvent cast and/or cross-linked. The following examples demonstrate different types of resins that may be effectively used as the patch layer:

### Example 1: TPU Film

Trade Name: 18103 from SWM International

Composition: Thermoplastic polyurethane made out of Aromatic polyether

General Uses: textile lamination, medical devices

Extrusion method: blown film

Gauge: 1.0-10 mils (25-250 microns)

Properties: Smooth surface; Mid-range softening temperature; USP Class VI certified polymer; FDA CFR 175.105

Hardness: ASTMD-2240 Shore 84 A

Tensile stress @ 100% elongation: ASTMD-412 900 psi; 6.2 MPa

Tensile stress @ 300% elongation: ASTMD-412 1450 psi; 9.6 MPa

Tensile strength: ASTMD-412 5500 psi; 37.9 MPa

Elongation @ break: ASTMD-412% 540

Tensile set @ break: ASTMD-412% 40

Tear strength: ASTMD-6241 460 pli; 80.6 kN/m

Abrasion resistance: ASTMD-10442 20 mg loss

### Example 2: TPU Film

Trade Name: 18433 from SWM International

Composition: Thermoplastic polyurethane made out of Aromatic polyether

General Uses: textile lamination, flame resistance

Extrusion method: blown film

Gauge: 1.0-10 mils (25-250 microns)

Properties: Smooth surface; Mid-range softening temperature; UL-94 V2; FAR 25.853 (A)

Hardness: ASTMD-2240 Shore 86 A

Tensile stress @ 100% elongation: ASTMD-412 1100 psi; 7.6 MPa

Tensile stress @ 300% elongation: ASTMD-412 1750 psi; 12 MPa

Tensile strength: ASTMD-412 4800 psi; 33.0 MPa

Elongation @ break: ASTMD-412% 640

Tear strength: ASTMD-624 600 pli; 105 kN/m

Abrasion resistance: ASTMD-1044 30 mg loss

### Example 3: SEBS Film

Trade Name: KRATONTM G1643 M [2]

Composition: Styrene Ethylene Butylene Styrene Block Copolymer (polystyrene content of 20%)

General Uses: a modifier of thermoplastics; find use in formulating adhesives, sealants, coatings

Extrusion method: Blown film, or linear extrusion followed by biaxial or uniaxial stretching.

Gauge: 1.0-10 mils (25-250 microns)

Properties: Surface can be modified to improve adhesion

Hardness: ASTMD-2240 Shore 52 A

Tensile strength: ASTMD-412>1500 psi

Elongation @ break: ASTMD-412>% 600

Melt Flow, 230C/2.16 kg: ASTM D1238 19 gms/10 min

### Example 4: Films from SEBS/Liquid PIB Blends

The examples in this category represent the versions of Example 3 modified with poly(isobutylene) (a.k.a. PIB, CAS# 9003-27-4) polymer.

Trade Name: KRATON™ G1643 M [2] & TPC 1160 AU 49019

TPC 1160 is a viscous non-drying polybutene polymer. TPC 1160 is non-toxic, imparts lubricity and tackiness, and corrosion protection.

TPC 1160 burns without residue, has good thermal stability, and superior dielectric properties. Supplied at 625-685 cSt at 100C (1,550 MW).

When blended with liquid PIB, SEBS become softer and more complaint with a 20-30% reduction at Shore A hardness values. The films (1-10 mils) are translucent and easy to be modified at surface for proper pigmentation using various color cosmetics. The examples include 3 units of SEBS blended with 1 or 2 units of PIB additive polymer. The blends can be solvent cast on smooth or frosted glass using paint thinner. The dry thicknesses can be ranged between 1 to 10 mils. Similar compositions can be linearly extruded excluding any organic solvents and using appropriate amount of antioxidant additives (e.g. 1.0% by wt. Irganox 1010).

### Example 5: Acrylic Films from PBMA/PBA Blends

Trade Name: N/A

Composition: poly(butyl acrylate) (CAS# 9003-63-8) & poly(butyl methacrylate) (CAS# 9003-49-0)

General Uses: find use in formulating adhesives, sealants, coatings

Extrusion method: Solvent Cast or Melt Extruded Films.

Gauge: 1.0-10 mils (25-250 microns)

Properties: Surface can be modified to improve adhesion

Poly(butyl methacrylate) (PBMA, Glass Transition Temperature ˜20° C.) can be compounded with poly(butyl acrylate) (PBA, Glass Transition

Temperature ˜−53° C.) as miscible blends at variable concentrations.

These blends form translucent soft films when co-extruded.

Two formulations of these resins were prepared in Toluene (20% Resin, 80% Solvent) and solvent cast on glass substrates to prepare 10 mil films.

PBMA:PBA (3:1 by wt.) Shore Hardness 75 A Pigmentation by color Cosmetic: Good to Acceptable Level

PBMA:PBA (3:2 by wt.) Shore Hardness 71 A Pigmentation by color Cosmetic: Acceptable Level when cast on Frosted Glass

In this example, the pigmentation of color cosmetics were improved when the formulations were cast on frosted glass, instead of smooth surfaces.

### II. Adhesive Layer

### Example 6: Silicones

In some embodiments, the adhesive may comprise silicones blended with curing agents and/or additives. Generally, the tack may decrease as the weight (thickness) of the adhesive coating decreases. The adhesive layer may be laid onto the patch layer using a slot die coater, gravure printer, reverse gravure printer, flexographic printer and/or by other means.

In some embodiments, the use of silicones demonstrates low skin irritation, low sensitization, and adequate repositionability on the skin.

In some embodiments, the following resins may be used at a 1-3 mil thickness range:
1) poly(ethylene-co-propylene-co-ethylidenenorbornene)
2) BW3X #98; Terpolymer butyl acrylate-co-glycidyl methacrylate-co-HEMA
3) PETROLEUM HYDROCARBON RESIN; CYCLOPENTADIENE from Nashville Chemical Company

### Example 7: Cross-Linked Silicone Gel Adhesive

In some embodiments, gel is generally formed by crosslinking reactions between linear or branched silicones having reactive groups during curing. A preferred example of cross-linking reactions includes the hydrosilylation reaction in which organosiloxane having a Si-H reactive group reacts with alkenyl substituted polydiorganosiloxane in the presence of a plantinum catalyst.

Preferred siloxane components are generally used in the reaction at 1:1 ratio and cure at normal ambient temperatures, but the cure reaction may be accelerated at elevated temperature.

The consistency, strength, softness and tackiness may be adjusted by a number of factors including the ratio of reactive groups in the materials, the viscosity of siloxane fluids, and coating weights of gel to obtain a product with the properties desired for a given use. Examples may include Vinyl terminated Polydimethylsiloxane (PDMS) and/or Hydrogen terminated PDMS.

### Example 8: Hydrocolloid Absorbent

The inventors determined the following: In general, at wound care applications, the hydrophilic material is capable of swelling in water, transporting water, and is preferably soluble in water. It generally absorbs excess perspiration or draining fluid from a wound, forming a gel that gets trapped in the bandage, turning the area of the gel white. Hydrocolloid may also assist in keeping the underlying area moist at a preferred level, a key tenet in a wound-healing bandage. The inventors realized that the hydrocolloid absorbent may reduce the tack to desirable levels and moderate the aggressiveness of the adhesive.

In general, Hydrocolloid functions as an absorbent, and provides the “wet tack” that enhances the ability of the adhesives to adhere to the skin and mucous membranes when they are moist. When the skin is dry, the tack may remain generally moderate.

In some embodiments, the hydrophilic component preferably has a low level of extractability from the adhesive and is not readily extracted from the adhesive by the moisture. Examples include Carboxymethyl Cellulose (CMC), PEG 3400, D-Mannitol, Pectin, and Gelatin.

### Example 9: Preparation of Hydrocolloid Silicone Adhesive

In some embodiments, the following materials were used:
1. MG 7-9900: A two -part silicone soft skin adhesive, the two components obtained from Dow Corning, Midland, Mich., under the trade designations “DOW CORNING MG 7-9900A” and “DOW CORNING MG 7-9900B”
2. CMC: Carboxymethylcellulose (“CMC”) obtained from Ashland under the trade designation “Aqualon”
3. PEG 3400: Polyethylene glycol, MW 3400 g/mol, Aldrich Chemical Company, Milwaukee, Wis.
4. D-Mannitol: D-Mannitol obtained from Alfa Aesar, Ward Hill, Mass.

In one embodiment, 50 grams of MG 7-9900 (part A) and 50 grams of MG 7-9900 (part B) were mixed together and blended for 90 seconds at 800 rpm in a mixer (Ross. MODEL LCI-t High Shear Mixer) to form a homogenous solution. The additives were then added, and the mixture was mixed again for 90 seconds at 2500 rpm. The solution was then coated at 125 micrometers onto a 25 micrometer polyurethane film. The coating was then heated to 90° C. for 3 minutes to facilitate the crosslinking of the silicone adhesive.

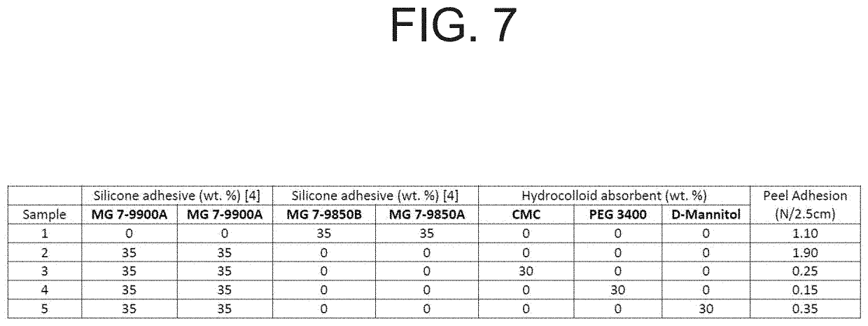

FIG. 7 shows the formulations demonstrated and the peel adhesion of each resulting adhesive.

It will be understood by a person of ordinary skill in the art, upon reading this specification, that any of the embodiments and/or examples described herein or otherwise may be combined in any way to form additional embodiments that are all within the scope of the system 10 and/or the patch 12.

It is also understood that the system 10 and/or patch 12 may or may not include any and/or all of the aspects of any of the various embodiments described herein or otherwise.

Those of ordinary skill in the art will appreciate and understand, upon reading this description, that embodiments hereof may provide different and/or other advantages, and that not all embodiments or implementations need have all advantages.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A system for protecting skin from contaminants, the system including:
a first patch contoured to cover a user's first body part comprising:
a first patch first layer adapted to receive makeup; and
a first patch second layer including adhesive;
wherein the first patch is applied to the user's first body part using the adhesive of the first patch second layer, and makeup is applied to the first patch first layer.

2. The system of claim 1 wherein the first patch first layer is adapted to block bacteria and/or viruses from the first body part.

3. The system of claim 1 wherein the first body part is selected from the group: left eyelid, right eyelid, left cheek, right cheek, upper lip and lower lip.

4. The system of claim 1 wherein the first patch is transparent.

5. The system of claim 1 wherein the first patch includes a pigment.

6. The system of claim 1 wherein a top surface of the first patch first layer includes a rough texture.

7. The system of claim 1 wherein the first patch further comprises a first patch third layer adapted to cover the adhesive of the first patch second layer, and wherein the first patch third layer is removeable from the first patch.

8. The system of claim 1 further comprising:
a second patch contoured to cover a user's second body part comprising:
a second patch first layer adapted to receive makeup; and
a second patch second layer including adhesive;
wherein the second patch is applied to the user's second body part using the adhesive of the second patch second layer, and makeup is applied to the second patch first layer.

9. A patch contoured to cover a user's first body part and adapted to receive makeup, the patch comprising:
a first layer adapted to receive the makeup; and
a second layer including adhesive;
wherein the patch is applied to the user's first body part using the adhesive of the second layer, and makeup is applied to the first layer.

10. The patch of claim 9 wherein the first layer is adapted to block bacteria and/or viruses from the first body part.

11. The patch of claim 9 wherein the first body part is selected from the group: left eyelid, right eyelid, left cheek, right cheek, upper lip and lower lip.

12. The patch of claim 9 wherein the patch is transparent.

13. The patch of claim 9 wherein the patch includes a pigment.

14. The patch of claim 9 wherein a top surface of the first layer includes a rough texture.

15. The patch of claim 9 wherein the first patch further comprises a third layer adapted to cover the adhesive of the second layer, and wherein the third layer is removeable from the patch.

16. The patch of claim 9 wherein the first layer includes a thermoplastic polyurethane film and the second layer includes a silicon adhesive.

17. The patch of claim 16 wherein the first layer is about 1.0 to 1.5 mil thick.

18. A method for applying makeup to a person's body parts, the method comprising:
(A) providing a first patch including a first patch first layer and a first patch second layer;
(B) providing a texture to a top surface of the first patch first layer;
(C) providing adhesive to a bottom surface of the first patch second layer;
(D) contouring the first patch to cover the user's first body part;
(E) applying the first patch to the first body part using the adhesive of the first patch second layer; and
(F) applying makeup to the top surface of the first patch first layer.

19. The method of claim 18, further comprising:
(G) providing a second patch including a second patch first layer and a second patch second layer;
(B) providing a texture to a top surface of the second patch first layer;
(C) providing adhesive to a bottom surface of the second patch second layer;
(D) contouring the second patch to cover the user's second body part;
(E) applying the second patch to the second body part using the adhesive of the second patch second layer; and
(F) applying makeup to the top surface of the second patch first layer.

20. The method of claim 18 wherein the first body part is selected from the group: left eyelid, right eyelid, left cheek, right cheek, upper lip and lower lip.
